(19) United States
(12) Patent Application Publication
(10) Pub. No.: US 2026/0149506 A1
(43) Pub. Date: May 28, 2026

(54) CONTROLLING RECEIVER LOCAL OSCILLATOR POWER IN A COHERENT MODEM TO IMPROVE SNR AND INCREASE RECEIVER DYNAMIC RANGE

(71) Applicant: Ciena Corporation, Hanover, MD (US)

(72) Inventors: Scott Kuntze, Ottawa (CA); Michael Vitic, Chelsea (CA); Ian Betty, Ottawa (CA); Ronald Hartman, Fitzroy Harbour (CA)

(73) Assignee: Ciena Corporation, Hanover, MD (US)

(21) Appl. No.: 19/176,470

(22) Filed: Apr. 11, 2025

Related U.S. Application Data
(63) Continuation-in-part of application No. 18/960,609, filed on Nov. 26, 2024.

(51) Int. Cl. H04B 10/564; H04B 10/079; H04B 10/50; H04B 10/67

(52) U.S. Cl. CPC H04B 10/564; H04B 10/07955; H04B 10/503; H04B 10/672

(57) ABSTRACT

Aspects of the subject disclosure may include, for example, mixing a local oscillator (LO) signal produced by a LO source and an incoming optical signal to produce a beat signal having a beat signal power, monitoring the beat signal power, and responsive to the monitoring, adjusting an optical power of the LO signal to control the beat signal power. Other embodiments are disclosed.

### CROSS-REFERENCE TO RELATED APPLICATION(S)

This application is a Continuation-In-Part of U.S. patent application Ser. No. 18/960,609, filed on Nov. 26, 2024. All sections of the aforementioned application(s) and/or patent(s) are incorporated by reference herein in their entirety.

### FIELD OF THE DISCLOSURE

The subject disclosure relates to a method and apparatus for regulating power supplied by a local oscillator source in an optical modem.

### BACKGROUND

Traditional wavelength-division multiplexing (WDM) networks require precise wavelength tuning, necessitating expensive tunable lasers. These systems typically share a single tunable laser between the transmitter and receiver, allocating a portion of the laser's power to the receiver as it relates to a local oscillator source. This allocation often falls short of optimizing the receiver's signal-to-noise and distortion ratio (SNDR).

Datacenter networks, which utilize fewer wavelength channels, can employ lower-cost lasers with relaxed tuning precision. This configuration allows for dedicated lasers for both the transmitter and receiver, enabling increased power to improve SNDR. However, increasing power poses a risk of exceeding the operational limits of components in an optical modem, potentially leading to damage. Variations in responsivity over wavelength during tuning can further complicate this balance, necessitating a control mechanism to optimize SNDR while protecting sensitive components from overload.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of an optical modem in accordance with various aspects described herein.

FIGS. 2A, 2B, 2C, 2D, 2D, and 2F show plots illustrating exemplary, non-limiting embodiments depicting operations of an optical modem in accordance with various aspects described herein.

FIG. 3 is a block diagram illustrating an exemplary, non-limiting embodiment of a receiver path of an optical modem in accordance with various aspects described herein.

FIG. 4 is a block diagram illustrating an exemplary, non-limiting embodiment of a detector of an amplifier in the optical modem of FIG. 3 in accordance with various aspects described herein.

FIG. 5A depicts an illustrative embodiment of a method utilized by an optical modem in accordance with various aspects described herein.

FIG. 5B depicts an illustrative embodiment of a method utilized by an optical modem in accordance with various aspects described herein.

FIGS. 6, 7, and 8 are block diagrams illustrating exemplary, non-limiting embodiments of receiver paths of optical modems in accordance with various aspects described herein.

FIG. 9 is a block diagrams illustrating exemplary, non-limiting embodiments of a LO VOA architecture in which a common LO is used in both signal optical polarizations in accordance with various aspects described herein.

FIG. 10 is a block diagrams illustrating exemplary, non-limiting embodiments of a LO VOA architecture in which distinct VOAs are used in each signal optical polarization in accordance with various aspects described herein.

FIG. 11 depicts an illustrative embodiment of a method utilized by an optical modem in accordance with various aspects described herein.

### DETAILED DESCRIPTION

The subject disclosure describes, among other things, illustrative embodiments for optimizing signal-to-noise and distortion ratio (SNDR) of an optical modem while managing power supplied by a local oscillator source to prevent components of the optical modem from exceeding their operation range. Other embodiments are described below.

Optical communications involve the transmission of data using light signals through optical fibers. This field encompasses various technologies and methods to enhance data transmission efficiency, speed, and reliability. Optical modems play a crucial role in converting electrical signals to optical signals and vice versa, enabling high-speed data communication over long distances. Optical modems often employ components such as lasers, photodetectors, and amplifiers to facilitate the modulation and demodulation of light signals.

A challenge in optical modems includes managing the power levels of local oscillator sources to optimize SNDR while preventing damage to photodetectors and amplifiers. Variations in responsivity over different wavelengths can lead to fluctuations in photocurrent, posing further risks of overload. These challenges necessitate the development of control mechanisms to balance power optimization with component protection as will be addressed in the embodiments that follow.

One or more aspects of the subject disclosure includes a method for mixing a local oscillator (LO) signal produced by a LO source and an incoming optical signal to produce a received optical signal directed to one or more photodetectors to produce a photocurrent that is supplied to an amplifier. The method further includes monitoring the photocurrent supplied to the amplifier, and responsive to the monitoring, causing the LO source to perform an adjustment of an optical power of the LO signal to control the photocurrent supplied to the amplifier.

One or more aspects of the subject disclosure includes an optical modem that has a local oscillator (LO) source configured to produce a LO signal, a mixer configured to mix the LO signal and an incoming optical signal to produce a received optical signal, one or more photodetectors configured to produce a photocurrent from the received optical signal, an amplifier configured to generate an output signal based on the photocurrent, and a controller. The controller can be configured to perform operations including monitoring the photocurrent supplied to the amplifier, and responsive to the monitoring, causing the LO source to perform an adjustment of an optical power of the LO signal to control the photocurrent supplied to the amplifier.

One or more aspects of the subject disclosure includes a non-transitory machine-readable medium, comprising executable instructions that, when executed by a processing system including a processor, facilitate performance of operations. Such operations can include monitoring a measurement associated with a photocurrent supplied to an amplifier. The photocurrent can be produced by one or more photodetectors according to a received optical signal produced by mixing a local oscillator (LO) signal produced by a LO source and an incoming optical signal. The operations further include causing the LO source to perform an adjustment of an optical power of the LO signal to control the photocurrent supplied to the amplifier.

In one or more aspects of the subject disclosure the adjustment of the optical power of the LO signal prevents the photocurrent produced by the one or more photodetectors from exceeding an operational threshold.

In one or more aspects of the subject disclosure adjustment of the optical power of the LO signal adjusts the photocurrent produced by the one or more photodetectors to improve operation of an analog-to-digital converter (ADC) coupled to the amplifier.

In one or more aspects of the subject disclosure the monitoring of the photocurrent can be performed by a detection circuit that performs a measurement of the photocurrent. In one or more aspects of the subject disclosure the detection circuit can comprise a received signal strength indicator (RSSI) circuit. In one or more aspects of the subject disclosure the detection circuit has a tunable gain. In one or more aspects of the subject disclosure the above embodiments further include adjusting the tunable gain of the detection circuit to adjust the measurement produced by the detection circuit.

In one or more aspects of the subject disclosure the detection circuit is coupled to a pre-amplifier stage of the amplifier.

In one or more aspects of the subject disclosure the amplifier comprises a transimpedance amplifier.

In one or more aspects of the subject disclosure the amplifier has a tunable gain adjustable by a primary control loop, and the adjustment of the optical power of the LO signal is performed by a secondary control loop. In one or more aspects of the subject disclosure the adjustment of the optical power of the LO signal by the secondary control loop occurs at a substantially equal or slower rate than adjusting the tunable gain of the amplifier by the primary control loop.

In one or more aspects of the subject disclosure the LO source is not shared with a transmitter of the optical modem. In one or more aspects of the subject disclosure the LO source is shared between a receiver and a transmitter of the optical modem, and power generated by the LO source that is directed to the receiver is adjustable.

In one or more aspects of the subject disclosure the above embodiments further include tuning a wavelength of the LO source to match the incoming optical signal.

One or more aspects of the subject disclosure include a method performed by an optical modem, comprising mixing a local oscillator (LO) signal and an incoming optical signal to produce a beat signal having a beat signal power. The method further includes monitoring the beat signal power and, responsive to the monitoring, adjusting an optical power of the LO signal to control the beat signal power.

Additional aspects of the subject disclosure may include a method wherein the adjusting of the optical power of the LO signal comprises causing a variable optical attenuator to attenuate the LO signal. The method may further involve monitoring the beat signal power with a received signal strength indicator (RSSI) circuit, and specifically monitoring the RSSI of the beat signal prior to a transimpedance amplifier (TIA). Additionally, the method may include monitoring a digital signal in a signal path that includes a TIA and an analog-to-digital converter to produce a measured beat signal power. In response to the measured beat signal power, the method may further comprise modifying a gain of the TIA. The adjusting of the optical power of the LO signal may involve reducing the optical power to decrease the beat signal power or increasing the optical power to enhance the beat signal power.

One or more aspects of the subject disclosure include an optical modem comprising a local oscillator (LO) source configured to produce a LO signal, a mixer configured to mix the LO signal and an incoming optical signal to produce a beat signal having a beat signal power, one or more photodetectors configured to convert the beat signal into a photocurrent, and a transimpedance amplifier (TIA) configured to amplify the photocurrent to generate an output signal. The optical modem further comprises a variable optical attenuator (VOA) positioned in a path of the LO signal, configured to adjust the optical power of the LO signal in response to a VOA control signal, a power measurement device configured to measure the beat signal power and produce a signal representing the measured beat signal power, and a feedback circuit configured to modify the VOA control signal in response to the signal representing the measured beat signal power, thereby optimizing the signal-to-noise and distortion ratio (SNDR) of the optical modem while preventing overload of the photodetectors and the TIA.

Additional aspects of the subject disclosure may include an optical modem further comprising a variable gain transimpedance amplifier (TIA) coupled in a signal path between the mixer and the power measurement device, wherein the feedback circuit is coupled to modify a gain of the variable gain TIA in response to the measured beat signal power. The optical modem may also include an analog-to-digital converter in the signal path between the variable gain TIA and the power measurement device, wherein the power measurement device comprises a digital circuit to produce a digital value that represents the measured beat signal power. Furthermore, the optical modem may comprise a transimpedance amplifier (TIA), wherein the power measurement device is coupled in a signal path between the mixer and the TIA. Additionally, the optical modem may include a LO source to produce the LO signal, wherein the LO source is configured to modify a power of the LO signal responsive to the feedback circuit.

One or more aspects of the subject disclosure include an apparatus comprising a variable optical attenuator (VOA) coupled to receive an optical local oscillator (LO) signal and to produce an output LO signal, with the VOA configured to adjust the optical power of the output LO signal in response to a VOA control signal. The apparatus further includes a mixer configured to mix the output LO signal and an incoming optical signal to produce a beat signal having a beat signal power, and one or more photodetectors configured to convert the beat signal into a photocurrent. Additionally, the apparatus comprises a transimpedance amplifier (TIA) configured to amplify the photocurrent to generate a voltage output signal representing the beat signal, a power measurement device configured to measure the beat signal power and produce a signal representing the measured beat signal power, and a feedback circuit configured to modify the VOA control signal in response to the signal representing the measured beat signal power.

Additional aspects of the subject disclosure may include an apparatus wherein the feedback circuit is configured to modify the VOA control signal to prevent the beat signal power from exceeding an operational threshold. The apparatus may further comprise a transimpedance amplifier (TIA) that includes a variable gain, with the feedback circuit being further configured to modify the variable gain of the TIA. Additionally, the power measurement device may comprise a received signal strength indicator (RSSI) circuit positioned prior to the TIA, or alternatively, a digital circuit located after the TIA to produce a digital value that represents the measured beat signal power.

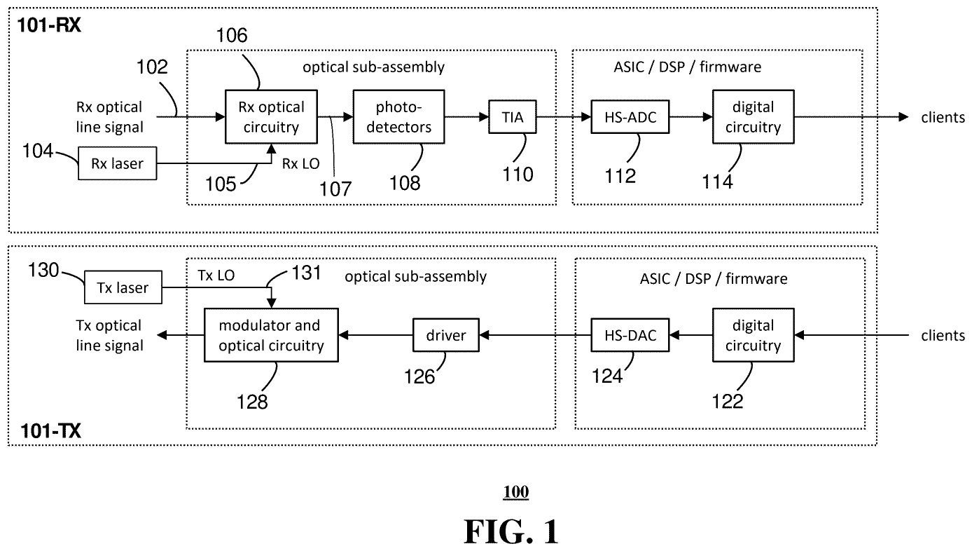

FIG. 1 is a block diagram illustrating an exemplary, non-limiting embodiment of an optical modem 100 in accordance with various aspects described herein. The optical modem 100 can include an optical sub-assembly section and an ASIC/DSP/Firmware section for a receiver path 101-RX and transmit path 101-TX. The receive path 101-RX includes a receiver (Rx) laser 104 that serves as a local oscillator (LO) source supplying an Rx LO signal 105 to Rx optical circuitry 106 receiving an Rx optical line signal 102. The Rx optical circuitry 106 functions as a mixer by combining the Rx LO signal 105 from the Rx laser 104 with the incoming Rx optical line signal 102. This combination allows the extraction of a desired optical signal of one or more specific wavelengths, shown as beat signal 107. The Rx optical circuitry 106 facilitates coherent detection, enabling the extraction of both amplitude and phase information from the incoming optical signal 102, which is then directed to the photodetectors 108 for conversion into an electrical signal. This process is crucial for accurate signal processing and optimizing the signal-to-noise and distortion ratio (SNDR) in the receiver path 101-RX.

The photodetectors 108 are responsible for converting the optical signals received from the Rx optical circuitry 106 into photocurrents supplied to a transimpedance amplifier (TIA) 110, after which the received signals (e.g., the beat signal) can be represented as voltages. The TIA 110 amplifies the electrical signals generated by the photodetectors 108 providing the necessary amplification for further processing by a high-speed analog-to-digital converter (HS-ADC) 112. The digital circuitry 114 is part of the ASIC/DSP/firmware section of the optical modem 100, which processes the digital signals converted by the HS-ADC 112. The digital circuitry 114 performs signal processing, error correction, and data management, ensuring that the received data is accurately interpreted and transmitted to downstream client devices.

The transmit path 101-TX in FIG. 1 begins with the digital circuitry 122, which processes data for transmission. The high-speed digital-to-analog converter (HS-DAC) 124 converts these digital signals into analog signals, which are amplified by a driver 126 prior to being converted and modulated by a modulator and optical circuitry 128 into optical signals. The modulator and optical circuitry 128 modulate the optical signal by combining it with a Tx LO signal 131 supplied by a Tx laser 130 that serves as a local oscillator source for modulation.

It will be appreciated that although the Rx laser 104 and Tx laser 130 are depicted as separate LO sources, in alternative embodiments, FIG. 1 can be adapted to use a single LO source that splits power between the receiver path 101-RX and transmit path 101-TX. In embodiments where the distribution of power can be adjusted in the receiver path 101-RX, the embodiments described below can be applied to a single LO source that adjusts power of the Rx LO signal 106 supplied to the receiver path 101-RX to achieve similar or equal results.

As noted earlier, challenges in the receiver path 101-RX include managing the power levels of the local oscillator source 104 and/or power levels of the LO signal 105 through the use of a variable optical attenuator (VOA) to optimize SNDR while preventing damage to photodetectors 108 and the TIA 110 (or other types of amplifiers). Variations in responsivity over different wavelengths, aging, ambient temperature, or other environmental or physical changes can lead to fluctuations in photocurrent produced by the photodetectors 108, posing risks of overload to the photodetectors 108 and/or the TIA 110.

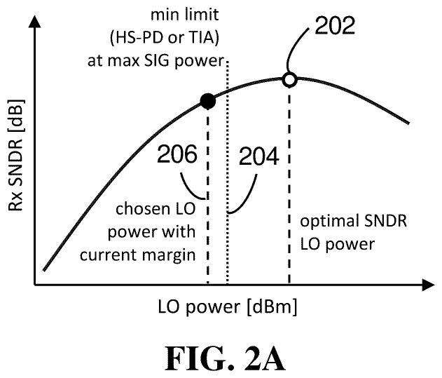

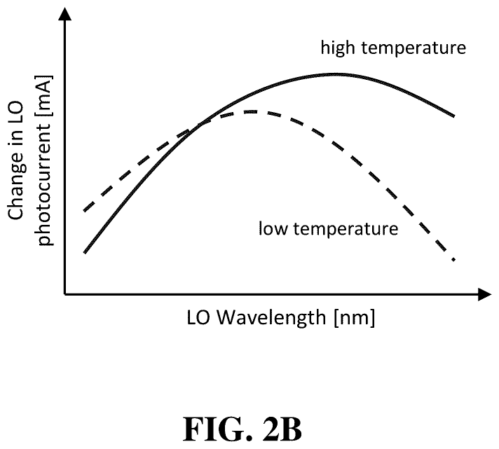

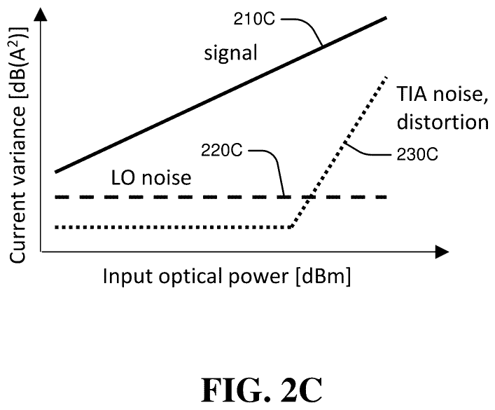

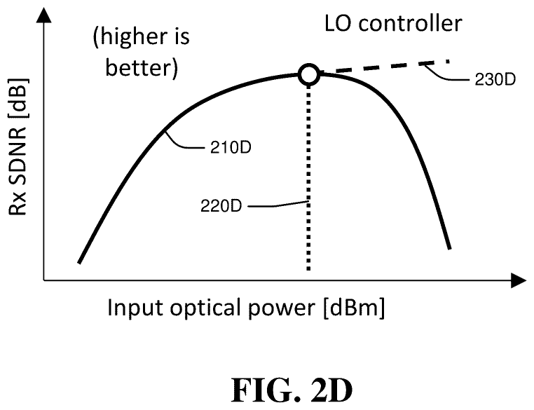

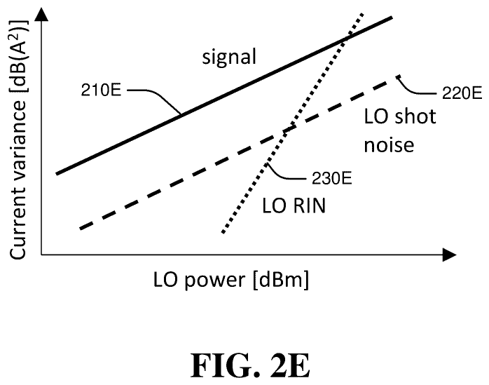

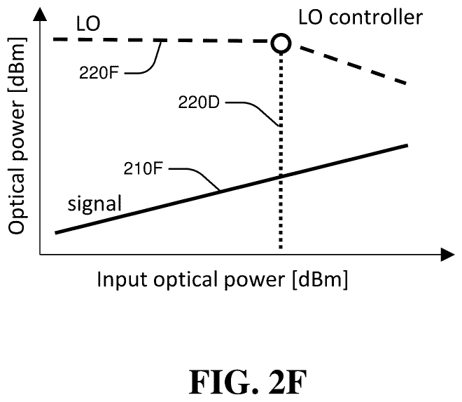

FIGS. 2A, 2B, 2C, 2D, 2D, and 2F show plots illustrating exemplary, non-limiting embodiments depicting operations of an optical modem 100 in accordance with various aspects described herein. Referring to FIG. 2A, during operations of the optical modem 100 in the receiver path 101-RX, SNDR rises as LO power of the Rx LO signal 105 increases because AC signal beat current rises with LO power faster than most noise sources. In optical modem applications, signal beat current refers to the interference that occurs when two optical signals of similar frequencies mix together, creating a beat signal. The beat signal can include unwanted noise terms that can cause distortions and degrade the performance of the communication system. With increasing LO power, LO RIN (Relative Intensity Noise) rises faster than signal beat current and thus there is a global Rx SNDR maximum 202 (denoted by an open circle) after which performance decreases. Ideally, the optical modem 100 could cause the Rx laser 104 to set LO power of the Rx LO signal 105 to this maximum, but too much input photocurrent may overload the photodetector 108 or the TIA 110 front-end (possibly causing damage) beyond an overload current threshold 204 that may occur below the SNDR maximum 202. To avoid an overload, the optical modem 100 can be configured to set an upper LO power limit 206 with some margin up to the overload current threshold 204 that maximizes Rx SNDR locally (depicted by solid dot).

Referring to FIG. 2B, despite a coarse wavelength grid, firmware must still tune wavelength while LO responsivity—and thus downstream photocurrent—varies over wavelength, sometimes by several dB depending on the wavelength tuning change and operating temperature (see low to high temperature ranges). When wavelength changes it may cause the photocurrent to encroach the overload current safety margin shown in FIG. 2A, and so it would be beneficial for the receiver path 101-RX to include a control loop to both maximize SNDR and protect the photodetector 108 or the TIA 110.

Referring to FIG. 2C, dominant noise sources in a coherent modem over input signal power are shown. The two dominant noise sources shown include LO shot noise 220C (dashed line), which is invariant over signal power, and TIA noise and distortion 230C (dotted line), which tends to be flat at lower input power and rise faster than the signal 210C (solid line) as photocurrent saturates the TIA's preamplifier.

Referring to FIG. 2D, the impact of LO shot noise and TIA SNDR over input signal power gives rise to a nonmonotonic receiver (Rx) signal-to-noise-and-distortion ratio 210D (SNDR, solid line), which degrades severely as signal power rises beyond a threshold input power 220D (dotted line, open circle). Various embodiments described further below reduce LO power above this threshold, holding (or possibly increasing) the optimal Rx SNDR even as signal power rises as shown at 230D (dashed line).

Referring to FIG. 2E, over LO power, signal noise 210E and LO shot noise 220E (dashed line) increases at the same rate as the LO power, but LO relative intensity noise 230E (RIN, dotted line) increases in proportion to the square of the LO power, so there is an optimal LO power above which SNR degrades. Furthermore, reducing LO power when LO RIN is prominent improves overall receiver SNR by reducing RIN at a faster rate.

Referring to FIG. 2F, because TIA noise and distortion in FIG. 2C causes the Rx SNDR reduction in FIG. 2D, the various embodiments described herein may hold the TIA gain constant by decreasing LO power 220F (dashed line) in proportion to the increase in signal power 220F (solid line) beyond the TIA optimal point 220D (dotted line, open circle).

As input optical signal power increases into a coherent receiver (Rx), Rx SNDR increases too but only until TIA thermal noise and distortion rise and begin to dominate, collectively rising faster than the increase in signal power as shown in FIG. 2C and causing Rx SNDR to then decrease above an optimal input power as shown in FIG. 2D. In previous generation modems without LO power control due to shared laser sources, a variable optical attenuator (VOA) in the signal path may have been used to reduce input optical power so that the TIA could remain at a fixed gain and clamp its noise at the optimal level, thus extending the receiver's dynamic range to higher input powers. In various embodiments described herein, the excess insertion losses associated with VOAs in the signal path are reduced, thereby limiting the effects of insertion loss (e.g., reduction in the maximum link length and overall performance of the modem).

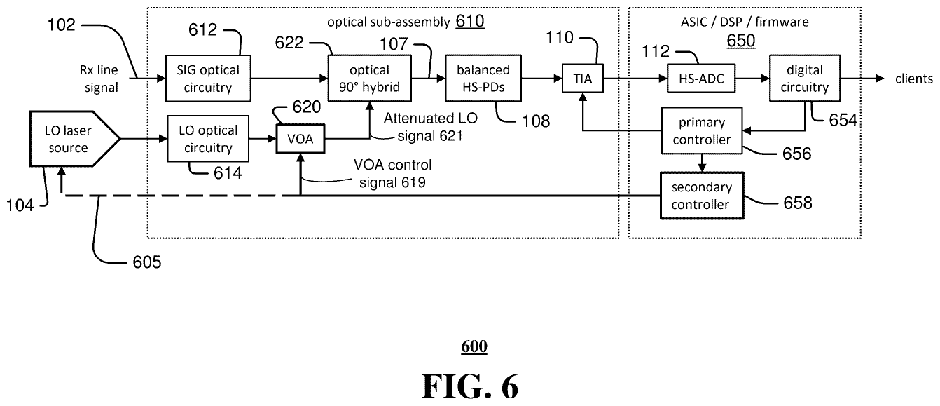

Various embodiments described herein reducing LO power instead of signal power. Reducing LO power in proportion to rising signal power above the Rx SNDR maximum allows the TIA gain to remain at its optimal setting, thereby flattening Rx SNDR as shown by the dashed extension in FIG. 2D. Furthermore, if the LO power is increased to optimize Rx SNR, decreasing LO power may increase Rx SNR above the TIA optimum because LO relative intensity noise (RIN) decreases in turn as illustrated in FIG. 2E. Various embodiments described below with reference to FIGS. 6-11 include a coherent receiver control architecture that controls LO power to optimize Rx SNDR. In some embodiments, a primary controller reads high-speed ADC (HS-ADC) power and controls the TIA gain to regulate HS-ADC differential input RMS voltage, while a secondary loop monitors the primary control signal and decreases LO power in proportion to increasing signal power (as shown in FIG. 2F) when the primary control signal drops below a prescribed threshold corresponding to the TIA gain at optimal Rx SNDR. The secondary loop minimizes the secondary error generated by subtracting the primary control signal and a predetermined LO threshold value that corresponds to the optimal TIA gain level; a secondary controller (PID, LQR, lead-lag, or similar) then minimizes the secondary error by adjusting LO power.

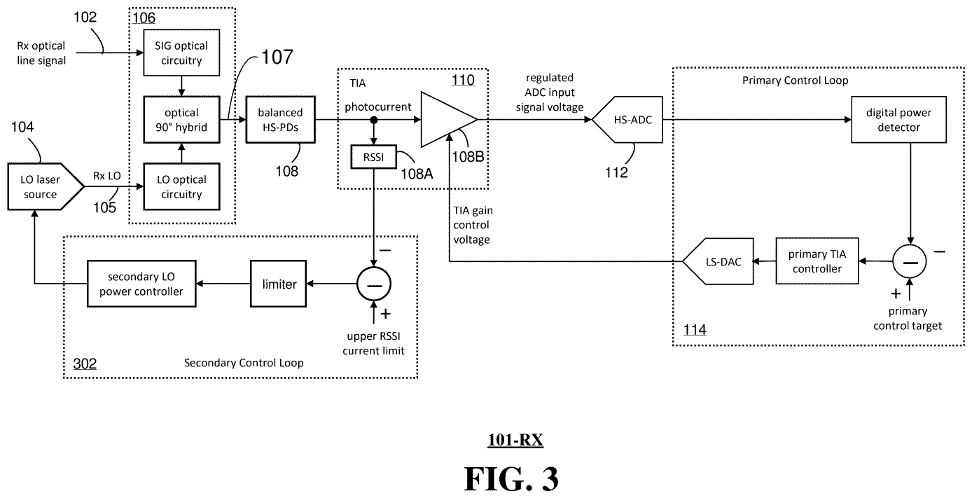

FIG. 3 is a block diagram illustrating an exemplary, non-limiting embodiment of an adaptation of the receiver path 101-RX of the optical modem 100 of FIG. 1 in accordance with various aspects described herein. The receiver path 101-RX comprises the Rx optical circuitry 106, which includes a signal (SIG) optical circuitry, an optical 90-degree hybrid and LO optical circuitry. The optical 90-degree hybrid is used to combine the Rx LO signal 104 conditioned by the LO optical circuitry with the incoming optical signal 102. The optical 90-degree hybrid splits the combined signal into two orthogonal components (e.g., In-Phase (I) and Quadrature (Q) phases), which are then directed to balanced high-speed photodiodes (HS-PDs) 108. The photocurrent generated by the balanced HS-PDs 108 is supplied to the TIA 110, which includes a detector 108A (illustrated as a Received Signal Strength Indicator or RSSI; herein RSSI detector 108A) that measures the photocurrent supplied to amplifier stages 108B of the TIA 110 whose gain is controlled by the digital circuitry 114. The digital circuitry 114 performs the function of a primary control loop that regulates the HS-ADC 112. For illustration purposes, the digital circuitry 114 will be referred to as the primary control loop 114.

The primary control loop 114 measures signal power utilizing a digital power detector, which is supplied to a TIA controller that utilizes an LS-DAC (Low Speed Digital to Analog Converter) to control gain of the TIA 110 and thereby regulates HS-ADCs 112 input voltage. The primary control loop 114 includes an error signal and primary control target signal to minimize error in the primary control loop 114. The primary control target signal shown in the primary control loop 114 can be calibrated at the time of manufacturing the optical modem 100 and can be adjusted during modem operation via firmware and/or hardware according to field temperature, age, characteristics of the optical signal being received (e.g., its format and/or levels), bandwidth of the optical signals, or other factors.

To achieve the objective of maximizing SNDR while protecting the photodetector 108 and/or the TIA 110, the optical modem 100 includes a secondary control loop 302. The secondary control loop 302 is enabled to direct the LO laser source 104 to raise LO power of the Rx LO signal 105 near the overload threshold 204 of FIG. 2A, thereby in turn raising SNDR of the receiver path 101-RX. The primary control loop 114 continues to regulate the input voltage of the HS-ADC 112 even as the secondary control loop 302 causes the LO Laser source 104 to adjust LO power of the Rx LO signal 105. In one embodiment, the secondary control loop 302 adjusts power of the Rx LO signal 105 to alter the downstream signal beat current generated in the HS-PDs 108. The secondary controller 302 is further configured to adjust power of the Rx LO signal 105 to mitigate changes in the main receiver (Rx) signal (SIG) 102. The secondary control loop 302 can perform other functions as will be described below, which collectively are intended to increase SNDR on the receive path 101-RX while preventing an overload condition at the photodetector 108 and/or the TIA 110.

It will be appreciated that the primary control loop 114 cannot regulate the input photocurrent of the TIA 110 because the primary control loop 114 has neither the required sensor (on TIA 110 input photocurrent) nor the required control (LO power) at the LO laser source 104. Thus, the receiver path 101-RX benefits from the secondary control loop coupled to the input of the TIA 110 to control the LO laser power of the LO laser source 104 directly or by some intermediary optical method.

To perform these functions, the secondary loop controller 302 includes a comparator to compare an upper RSSI current limit to the RSSI measurement, a limiting element, and a secondary LO power controller. The upper RSSI current limit sets a maximum allowable current level for the RSSI measurement to protect the HS-PDs 108 and/or the TIA 110 from photocurrent overload while optimizing SNDR. The limiting element ensures that the adjustments made by the secondary control loop 302 do not exceed predefined limits. The secondary LO power controller (microprocessor, ASIC or other computing device) directs the LO laser source 104 to adjust the power of the Rx LO signal 105 either directly via laser bias current or by indirect optical attenuation. This adjustment helps to maintain optimal performance of SNDR and prevents overload in the HS-PDs 108 and/or the TIA 110. The secondary control loop 302 is typically digital and runs in firmware, but other embodiments are possible including those implemented entirely in the analog domain or integrated directly into ASIC logic. The secondary control loop 302 can be implemented as Proportional-Integral-Derivative (PID), a lead/lag compensator, a Linear Quadratic Regulator (LQR), or other types of control loop feedback configurations.

It will be appreciated that the adjustments performed by the primary control loop 114 to regulate HS-ADCs 112 input voltage and adjustments made by the secondary control loop 302 to regulate power generate by the LO laser source 104 can occur at a substantially equal rate. In other embodiments the secondary control loop 302 can operate at slower rate than the adjustments made by the primary control loop 114. It will be further appreciated that in order to provide the secondary loop controller 302 the ability to adjust the LO power of the Rx Laser 104, in one embodiment, the Rx Laser 104 is not shared with the transmitter path 101-TX. However, as was mentioned earlier, the subject disclosure can be applied to a single LO source split between the receiver path 101-RX and transmit path 101-TX when the power supplied to the receiver path 101-RX is adjustable by the secondary control loop 302.

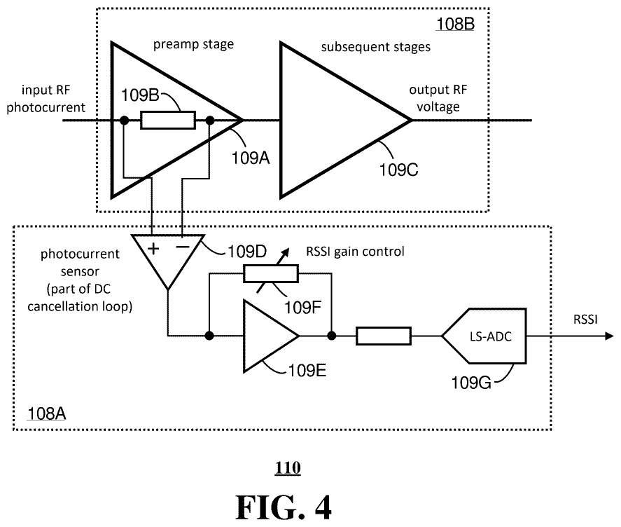

FIG. 4 is a block diagram illustrating an exemplary, non-limiting embodiment of the TIA 110 of the optical modem 100 of FIG. 3 in accordance with various aspects described herein. The amplifier 108B of the TIA 110 includes a preamp stage 109A that contains a DC-cancellation loop that senses with a photocurrent sensor 109D input photocurrent using a voltage drop across a resistive (and possibly active) element 109B of the preamp stage 109A. This voltage difference passes through a variable gain amplifier buffer stage 109E (with possibly active elements) and into a low-speed analog to digital converter (LS-ADC) 109G integrated inside the TIA 110, which firmware reads periodically using a protocol like the serial peripheral interface (SPI) or similar. The variable gain amplifier buffer stage 109E also includes an RSSI gain control 109F that can be controlled by the secondary control loop 302 (or other firmware in the optical modem 100) to adjust the fidelity of the RSSI measurement. Note that FIG. 4 illustrates conversion to the digital domain via the LS-ADC 109G. In alternative embodiments, the secondary control loop 302 (or other firmware in the optical modem 100) can be adapted to use the analog RSSI signal directly. The input RF photocurrent supplied to the preamp stage 109A continues downstream to subsequent gain stages 109C including the gain-control stage used by the primary control loop 114.

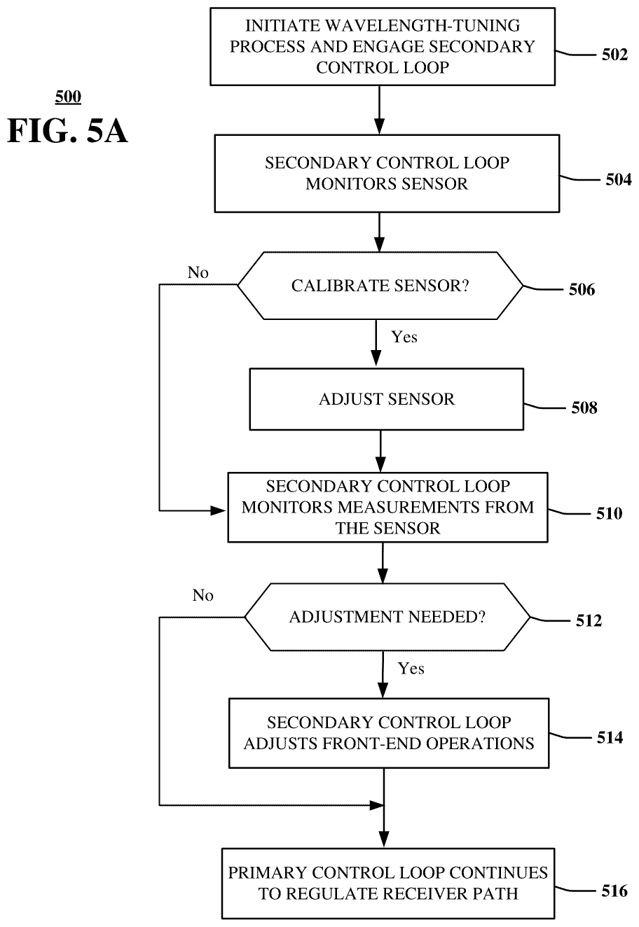

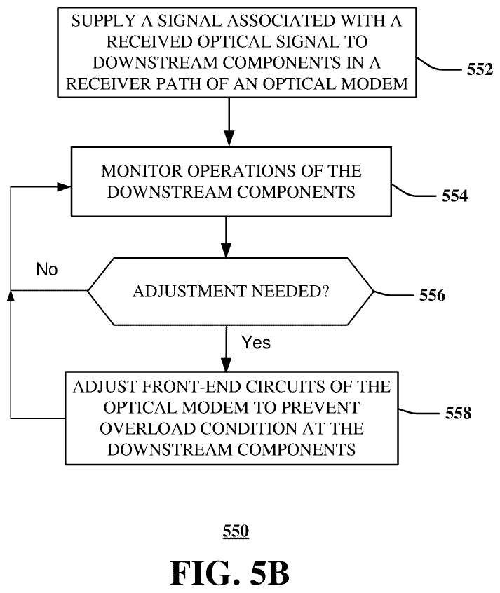

FIG. 5A depicts an illustrative embodiment of a method 500 utilized by an optical modem in accordance with various aspects described herein. The process begins at step 502, where wavelength tuning process is initiated by a receive path of the optical modem, which engages a secondary control loop to monitor operations of one or more components (e.g., photodetectors and/or amplifiers) of the receive path to ensure these components do not experience an overload condition. At step 504, the secondary control loop (or other firmware or control loops in the optical modem) monitors the performance of a sensor (e.g., RSSI detector) coupled to the one or more components being monitored. The sensor generates measurements associated with one or more signals (e.g., photocurrent and/or voltages) of the components. At step 506, the secondary control loop (and/or other firmware) can determine if the sensor needs calibration to improve the fidelity of these measurements. If so, the process moves to step 508 where the sensor is adjusted (e.g., recalibrating a variable gain control of an RSSI detector) to improve the fidelity of the measurement generated by the sensor to arrive at a new baseline value.

If it is determined at step 506 that an adjustment is not necessary, the process turns to step 510 where the secondary control loop monitors measurements from the sensor to determine if the tuning process started at step 502 and adjusted by a primary control loop at step 516 to optimize the performance of the optical modem (e.g., SNDR) may lead to an overload condition at the one or more components (e.g., see FIG. 2A). If at step 512 the secondary loop controller detects that the tuning process or other factors may create an overload condition, the secondary loop controller will proceed to step 514 where it will adjust front-end operations of the optical modem (e.g., cause a laser to adjust its output power) to prevent the overload condition (e.g., reduce photocurrents supplied to an amplifier in the receive path) from occurring. If an overload condition is not anticipated in step 512, method 500 proceeds to step 516 where the primary control loop continues to regulate the receiver path (e.g., HS-ADC input signal voltage). The aforementioned steps are repeated during the tuning process.

While for purposes of simplicity of explanation, the respective processes are shown and described as a series of blocks in FIG. 5A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 5B depicts an illustrative embodiment of a method 550 utilized by an optical modem in accordance with various aspects described herein. The process begins at step 552, where a received signal is generated from an optical line signal by, for example, an optical mixer. The received signal is then supplied to downstream components (e.g., photodetectors and/or amplifiers) in the receive path of an optical modem. The downstream components process the received signal to generate a converted and amplified signal operating in the electrical domain. At step 554, operations of the downstream components are monitored with detection circuitry (e.g., RSSI detector) to determine if such components are operating within their operational range. The method then proceeds to decision step 556, where it is determined whether an adjustment is needed to avoid exceeding an operational threshold of one or more of downstream components in the receiver path of the optical modem. If an adjustment is required, the process moves to step 558, where front-end circuits of the optical modem are adjusted. The front-end circuits may be, for example, a LO laser source which is adjusted to change characteristics of a LO signal supplied by the LO laser source to the circuity generating the received signal (e.g., optical mixer). The adjusted characteristics of the LO signal can include an adjustment in power, wavelength, or other suitable characteristics. Such an adjustment helps to improve the SNDR of the optical modem while preventing an overload condition of the downstream components. The method repeats these steps, ensuring optimal performance and protection of the downstream components.

While for purposes of simplicity of explanation, the respective processes are shown and described as a series of blocks in FIG. 5B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 6 is a block diagram illustrating exemplary, non-limiting embodiments of receiver paths of optical modems in accordance with various aspects described herein. The receiver path 600 includes Rx laser 104 (also referred to herein as a LO laser source), optical sub-assembly 610, and ASIC/DSP/firmware assembly 650. Optical sub-assembly 610 includes the signal (SIG) optical circuitry 612, LO optical circuitry 614, variable optical attenuator (VOA) 620, optical 90° hybrid 622, balanced high-speed photodetectors (HS-PDs) 108, and TIA 110. Optical sub-assembly 610 handles the incoming optical signals and converts them into electrical signals for further processing.

ASIC/DSP/firmware 650 includes the high-speed analog-to-digital converter (HS-ADC) 652, digital circuitry 654, primary controller 656, and secondary controller 658. ASIC/DSP/firmware 650 may be implemented using a variety of configurations in various embodiments. For example, in some embodiments, block 650 may be implemented as dedicated hardware, such as an Application-Specific Integrated Circuit (ASIC), which is designed to perform specific tasks with high efficiency and speed. These embodiments may provide for handling high-speed data processing and signal management tasks. In other embodiments, a combination of dedicated hardware and firmware may be employed, where an ASIC may be used in conjunction with a processor (e.g., a microprocessor, microcontroller, Digital Signal Processor (DSP), or the like) running firmware. This hybrid approach allows for the benefits of hardware acceleration while maintaining the flexibility to update and modify processing algorithms through firmware changes. The processor can handle complex signal processing tasks, such as error correction and data management, while the firmware provides the ability to adapt to different operational requirements and environmental conditions. This combination ensures that the ASIC/DSP/firmware 650 can effectively manage the digital signals processed by the optical modem, maintaining optimal performance and reliability.

In operation, the LO laser source 104 produces the LO signal, which is directed through the LO optical circuitry 614. This circuitry is responsible for preparing the LO signal before mixing with the incoming Rx line signal 102. The LO optical circuitry 614 adjusts the LO signal to the appropriate power level and phase for effective mixing with the incoming signal. The variable optical attenuator (VOA) 620 is placed in the path of the LO signal to modify its power level. The VOA 620 is managed by a feedback circuit, which alters the VOA control signal 619 based on the measured beat signal power, ensuring the LO signal is at the optimal power level for mixing.

The optical 90° hybrid 622 serves as an optical mixer that merges the conditioned LO signal with the incoming Rx line signal 102. This mixing produces a beat signal 107, which includes both amplitude and phase information of the incoming signal. The optical 90° hybrid 622 divides the combined signal into two orthogonal components, which are subsequently directed to the balanced high-speed photodetectors (HS-PDs) 630. The balanced HS-PDs 630 transform the optical beat signal into a photocurrent, which is then provided to the transimpedance amplifier (TIA) 632.

The TIA 632 amplifies the photocurrent to generate a voltage output signal representing the beat signal. The TIA 632 functions as a variable gain amplifier, allowing for gain adjustment in response to the input signal power. This gain adjustment is managed by the primary controller 656, which is included in the ASIC/DSP/firmware section 650. The primary controller 656 responds to a power measurement provided by digital circuitry 654 and adjusts the TIA gain to maintain a proper input voltage to the HS-ADC 652.

The HS-ADC 652 converts the amplified analog signal from the TIA 632 into a digital signal for further processing by the digital circuitry 654. The digital circuitry 654 performs various signal processing tasks, including error correction and data management, and power measurement, ensuring that the received data is accurately interpreted and transmitted to downstream client devices. The secondary controller 658 is responsible for monitoring the primary control signal and adjusting the LO power in response to changes in the input signal power. The secondary controller 658 ensures that the LO power is optimized to maintain the desired signal-to-noise and distortion ratio (SNDR) while preventing overload conditions in the receiver path 600.

The secondary controller 658 plays a role in managing the power level of the attenuated LO signal 621 by dynamically adjusting the VOA control signal 619. This adjustment is based on feedback from the power measurement device, which monitors the beat signal power to ensure optimal signal-to-noise and distortion ratio (SNDR) while preventing overload conditions. By modifying the VOA control signal 619, the secondary controller can fine-tune the attenuation applied to the LO signal, ensuring that the power level is maintained within desired operational thresholds. Additionally, the secondary controller may also modify the control signal 605, which directly influences the LO laser source 104 to adjust its output power. In some embodiments, this dual approach may allow the secondary controller to balance the power levels effectively, either by attenuating the LO signal through the VOA or by altering the laser's output power, thereby providing a robust mechanism for maintaining optimal performance and protecting sensitive components within the optical modem.

The term “attenuated LO signal” does not inherently imply that the LO signal is always subject to attenuation. Instead, it refers to the capability of the system to adjust the LO signal power as needed to maintain optimal performance. For example, within certain ranges of input signal power, the variable optical attenuator (VOA) 620 may not attenuate the LO signal at all, allowing the full power of the LO signal to be utilized. This scenario is depicted in FIG. 2F, where the LO power is not attenuated by VOA 620 when the input signal power 210F is below the threshold input power 220D, and the LO power is attenuated by VOA 620 when the input signal power 210F is above the threshold input power 220D. As illustrated in FIG. 2D, when the input signal power exceeds the threshold, and LO signal power is attenuated, the Rx SNDR can be kept constant or even increased as signal power increases beyond the signal power threshold 220D. Accordingly, the term “attenuated LO signal” encompasses a range of operational states, from no attenuation to significant attenuation, depending on the input signal power and system requirements.

FIG. 6 shows one optical polarization of two, and one RF tributary of four in a typical coherent receiver—the optics are duplicated for a second optical polarization and the TIA, ASIC, and controllers are duplicated for each of the four RF tributaries in a typical implementation.

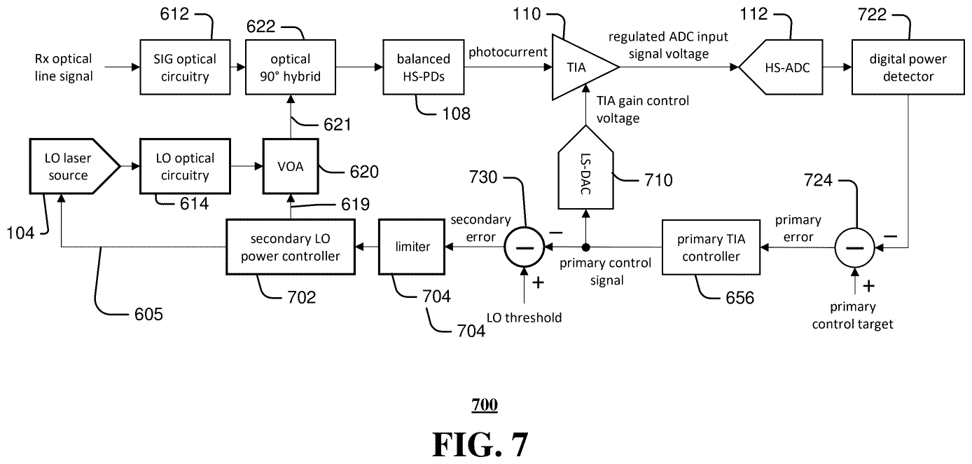

FIG. 7 is a block diagram illustrating exemplary, non-limiting embodiments of receiver paths of optical modems in accordance with various aspects described herein. Receiver path 700 integrates primary and secondary control loops to manage the beat signal power. The receiver path 700 includes the Rx laser 104, which serves as the local oscillator (LO) source, producing the LO signal that is directed through the LO optical circuitry 614. The SIG optical circuitry 612 receives the incoming Rx optical line signal and, together with the optical 90° hybrid 622, mixes it with the attenuated LO signal 621 to produce a beat signal. This beat signal is then converted into a photocurrent by the balanced high-speed photodetectors (HS-PDs) 108 and subsequently amplified by the transimpedance amplifier (TIA) 632.

The primary control loop in FIG. 7, corresponding to blocks 724, 656, and 710, is responsible for regulating the input voltage to the high-speed analog-to-digital converter (HS-ADC) 112. It achieves this by measuring the digital power samples and adjusting the TIA gain to maintain a consistent input voltage, ensuring optimal signal processing. The primary TIA controller 656, in conjunction with the LS-DAC 710, facilitates this regulation by minimizing the primary error relative to a primary control target.

The secondary control loop, corresponding to blocks 724, 656, 730, 704, and 702, functions to control the beat signal power. This loop engages when the primary control signal indicates that the beat signal power needs adjustment. The secondary LO power controller 702, along with the limiting element 704 and summer 730, modifies the VOA control signal 619 (and/or the LO laser source control signal 605) to adjust the LO power, thereby optimizing the signal-to-noise and distortion ratio (SNDR) while preventing overload conditions. This dual-loop system ensures that the receiver path 700 maintains high performance and reliability by dynamically managing the beat signal power in response to varying input conditions.

In the context of an optical modem, the beat signal, which is generated by mixing a local oscillator (LO) signal with an incoming optical signal, can be present at various stages within the signal path after the mixer. Initially, the beat signal is represented as an optical signal, which is then converted into a photocurrent by the photodetectors. This photocurrent serves as the input to the transimpedance amplifier (TIA), where it is amplified and converted into a voltage signal that continues to represent the beat signal. The TIA's output, therefore, is a voltage signal that maintains the characteristics of the original beat signal, albeit in an electrical form. As the signal progresses through the system, it reaches the high-speed analog-to-digital converter (HS-ADC), which digitizes the voltage signal. The output of the HS-ADC is a digital signal that still represents the beat signal, now in a format suitable for further digital processing and analysis. This transformation through various signal forms allows the beat signal to be effectively managed and utilized within the optical modem's signal processing chain.

The digital power detector 722 serves as an exemplary embodiment of a power detection circuit within the optical modem, specifically designed to measure the power of the beat signal in its digital form. As a digital power detection circuit, it processes the digitized output from the high-speed analog-to-digital converter (HS-ADC) to determine the beat signal power accurately. This digital approach allows for precise power measurement and integration with digital signal processing tasks. However, other embodiments may employ an analog circuit to measure the beat signal power, providing flexibility in how and where the power measurement is conducted. The power measurement can be performed at any point in the signal path where the beat signal is accessible, whether in its optical, electrical, or digital form. This versatility ensures that the power detection can be tailored to the specific requirements of the system, optimizing the signal-to-noise and distortion ratio (SNDR) and maintaining the integrity of the signal processing chain.

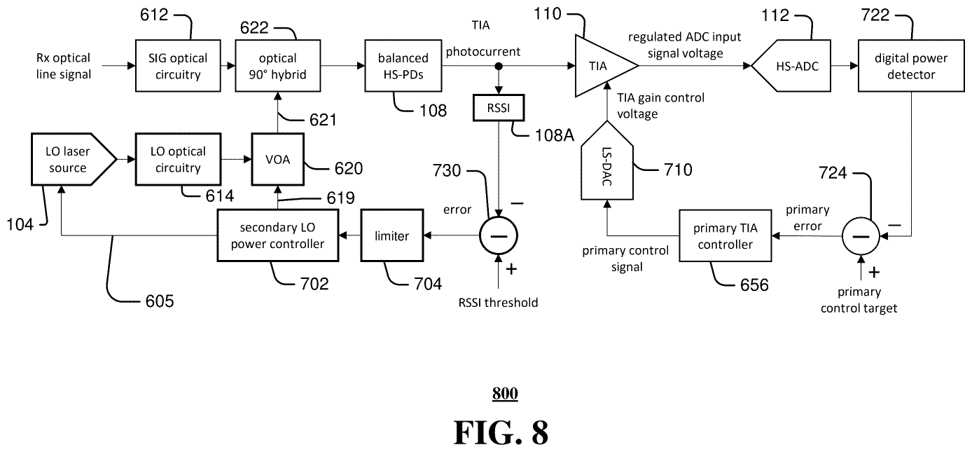

FIG. 8 is a block diagram illustrating exemplary, non-limiting embodiments of receiver paths of optical modems in accordance with various aspects described herein. Receiver path 800 is similar to the configuration shown in FIG. 7, with the primary distinction being the structure of the secondary control loop. The receiver path 800 includes the Rx laser 104, which serves as the local oscillator (LO) source, producing the LO signal that is directed through the LO optical circuitry 614. The SIG optical circuitry 612 receives the incoming Rx optical line signal and, together with the optical 90° hybrid 622, mixes it with the LO signal to produce a beat signal. This beat signal is then converted into a photocurrent by the balanced high-speed photodetectors (HS-PDs) 108 and subsequently amplified by the transimpedance amplifier (TIA) 110.

The primary control loop, as in FIG. 7, is responsible for regulating the input voltage to the high-speed analog-to-digital converter (HS-ADC) 652. It achieves this by measuring the digital power samples and adjusting the TIA gain to maintain a consistent input voltage, ensuring optimal signal processing. The primary TIA controller 656, in conjunction with the LS-DAC 710, facilitates this regulation by minimizing the primary error relative to a primary control target.

The secondary control loop in FIG. 8, however, incorporates the RSSI measurement 108A, which is described in FIG. 3, along with blocks 730, 704, and 702. This loop is designed to manage the beat signal power by utilizing the RSSI measurement to monitor the beat signal power represented by the photocurrent supplied to the TIA. The RSSI measurement provides real-time feedback on the signal strength, allowing the secondary LO power controller 702 to adjust the VOA control signal 619 and, if necessary, the LO laser source output. The limiting element 704 and summer 730 work in conjunction to ensure that the adjustments maintain the desired signal-to-noise and distortion ratio (SNDR) while preventing overload conditions. This configuration allows the receiver path 800 to dynamically manage the beat signal power, enhancing the performance and reliability of the optical modem.

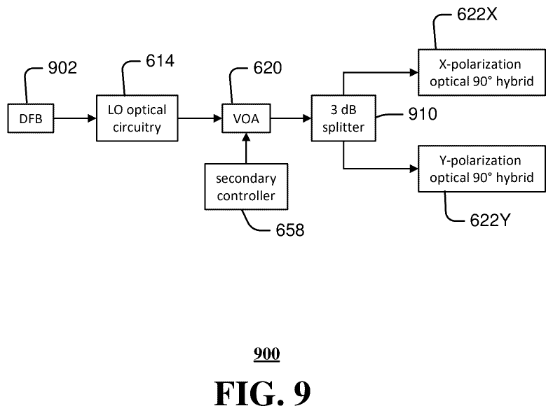

FIG. 9 is a block diagrams illustrating exemplary, non-limiting embodiments of a LO VOA architecture in which a common LO is used in both signal optical polarizations in accordance with various aspects described herein. System 900 includes a local oscillator (LO) architecture designed for use in optical communication systems. System 900 includes an Rx laser 902 (shown as a DFB), LO optical circuitry 614, a variable optical attenuator (VOA) 620, a secondary controller 658, a 3 dB splitter 910, an X-polarization optical 90° hybrid 622X, and a Y-polarization optical 90° hybrid 622Y.

The VOA 620 is placed in the path of the LO signal to adjust its power level. The secondary controller 658 manages the VOA, dynamically controlling the attenuation to optimize the signal-to-noise ratio and prevent saturation of downstream components. This control maintains the optical signal at a level suitable for further processing, adapting to varying input conditions.

The 3 dB splitter 910 divides the optical signal into two equal parts, directing them towards the X-polarization optical 90° hybrid 622X and the Y-polarization optical 90° hybrid 622Y. The X-polarization optical 90° hybrid 622X processes signals with X-polarization, converting them into electrical signals for further analysis. Similarly, the Y-polarization optical 90° hybrid 622Y processes signals with Y-polarization, converting them into electrical signals for further analysis.

Although splitter 910 is shown and described as a 3 dB splitter, the various embodiments described herein are not limited in this respect. For example, in some embodiments, the splitter may be other than a 3 dB splitter. If a particular implementation experiences more loss on one path (e.g., the Y-polarization path), the splitter may configured to send more power to this path to compensate. Accordingly, the various embodiments described herein may include a splitter 910 that performs a power split at any power split ratio.

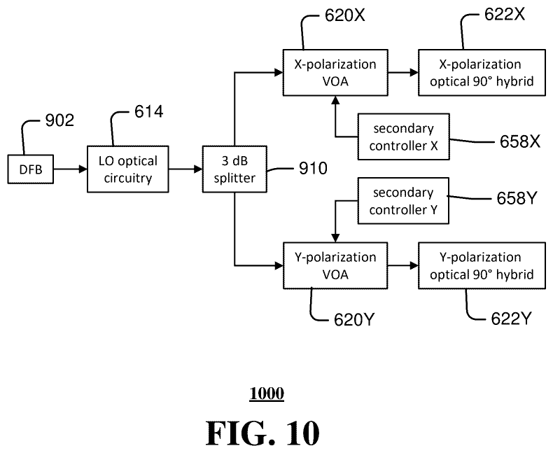

System 900 incorporates an architecture where a common LO is used for both signal optical polarizations. This configuration simplifies the system by using a single VOA before the LO 3 dB splitter, reducing controller complexity, size, and power consumption. However, if the VOA is nonlinear or breaks down at full LO power, two VOAs can be used after the 3 dB splitter, one for each signal polarization X and Y. This post-splitter configuration allows for independent optimization of each polarization, accommodating significant differences in signal polarization powers or varying loss through the optics. This is shown in FIG. 10.

FIG. 10 is a block diagrams illustrating exemplary, non-limiting embodiments of a LO VOA architecture in which distinct VOAs are used in each signal optical polarization in accordance with various aspects described herein. In the architecture of system 1000, each polarization path is equipped with its own VOA—620X for the X-polarization path and 620Y for the Y-polarization path. These VOAs are responsible for adjusting the power level of the LO signal in each polarization path, ensuring that the signal is maintained at an optimal level for further processing. The secondary controllers 658X and 658Y manage these VOAs, dynamically controlling the attenuation to optimize the signal-to-noise ratio and prevent saturation of downstream components. This architecture allows for independent optimization of each polarization, accommodating significant differences in signal polarization powers or varying loss through the optics. By using two VOAs after the 3 dB splitter, the system can avoid potential nonlinearities or breakdowns that might occur if a single VOA were used at full LO power.

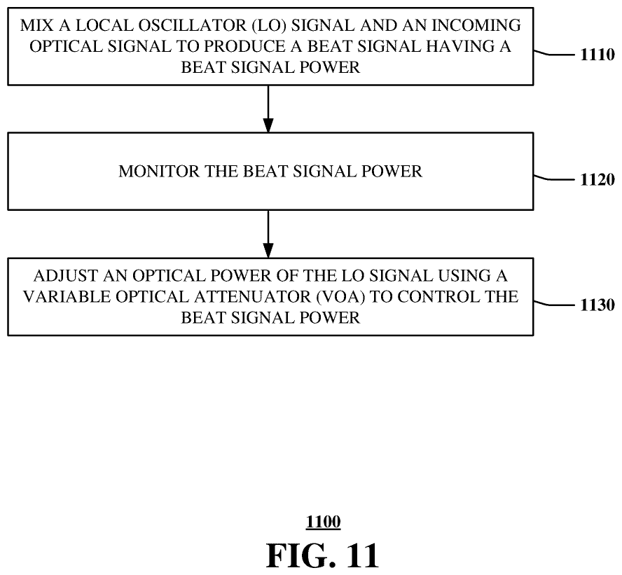

FIG. 11 depicts an illustrative embodiment of a method utilized by an optical modem in accordance with various aspects described herein. At block 1110, method 1100 includes mixing a local oscillator (LO) signal and an incoming optical signal to produce a beat signal having a beat signal power. In some embodiments, this action is performed by the optical 90° hybrid 622 in FIGS. 6-8, which combines the attenuated LO signal from the VOA 620 with the incoming Rx line signal 102, resulting in the beat signal.

At block 1120, the method includes monitoring the beat signal power. In some embodiments, this monitoring can be conducted by a received signal strength indicator (RSSI) circuit, such as the RSSI detector 108A in FIG. 8, which monitors the RSSI of the beat signal prior to the transimpedance amplifier (TIA) 632. In other embodiments, the digital power detector 722 in FIGS. 7 and 8 can monitor a digital signal in a signal path that includes the TIA 110 and the high-speed analog-to-digital converter (HS-ADC) 112 to produce a measured beat signal power.

At block 1130, the method includes adjusting an optical power of the LO signal to control the beat signal power. In some embodiments, this adjustment is achieved by causing the variable optical attenuator (VOA) 620 to attenuate the LO signal, as managed by the secondary controller 658 in FIG. 6 or the secondary LO power controller 702 in FIGS. 7 and 8. The adjustment can involve reducing the optical power of the LO signal to decrease the beat signal power or increasing it to enhance the beat signal power, depending on the monitoring results.

Further, in response to the measured beat signal power, the method may include modifying a gain of the TIA 110, as facilitated by the primary TIA controller 656 in FIGS. 7 and 8. This modification ensures that the TIA operates within optimal parameters, maintaining the desired signal-to-noise and distortion ratio (SNDR).

While for purposes of simplicity of explanation, the respective processes are shown and described as a series of blocks in FIG. 11, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method performed by an optical modem, comprising:
mixing a local oscillator (LO) signal and an incoming optical signal to produce a beat signal having a beat signal power;
monitoring the beat signal power; and
responsive to the monitoring, adjusting an optical power of the LO signal to control the beat signal power.

2. The method of claim 1, wherein the adjusting the optical power of the LO signal comprises causing a variable optical attenuator to attenuate the LO signal.

3. The method of claim 1, wherein the monitoring the beat signal power comprises monitoring a resultant high speed photodiode (HS-PD) photocurrent with a received signal strength indicator (RSSI) circuit.

4. The method of claim 3, wherein the monitoring the beat signal power comprises monitoring resultant HS-PD photocurrent at an input to a transimpedance amplifier (TIA).

5. The method of claim 1, wherein the monitoring the beat signal power comprises monitoring a digital signal in a signal path that includes a transimpedance amplifier (TIA) and an analog-to-digital converter to produce a measured beat signal power.

6. The method of claim 5, further comprising modifying a gain of the TIA in response to the measured beat signal power.

7. The method of claim 5, wherein the adjusting the optical power of the LO signal comprises reducing the optical power of the LO signal to reduce the beat signal power.

8. The method of claim 5, wherein the adjusting the optical power of the LO signal comprises increasing the optical power of the LO signal to increase the beat signal power.

9. An optical modem, comprising:
one or more variable optical attenuators (VOAs) configured to receive a local oscillator (LO) signal and to produce an attenuated LO signal in response to a VOA control signal;
a mixer configured to mix the attenuated LO signal and an incoming optical signal to produce a beat signal having a beat signal power;
a power measurement device configured to measure the beat signal power and to produce a signal representing a measured beat signal power; and
a feedback circuit configured to modify the VOA control signal in response to the signal representing the measured beat signal power.

10. The optical modem of claim 9, further comprising a variable gain transimpedance amplifier (TIA) coupled in a signal path between the mixer and the power measurement device, wherein the feedback circuit is coupled to modify a gain of the variable gain TIA in response to the measured beat signal power.

11. The optical modem of claim 10, further comprising an analog-to-digital converter in the signal path between the variable gain TIA and the power measurement device.

12. The optical modem of claim 11, wherein the power measurement device comprises a digital circuit to produce a digital value that represents the measured beat signal power.

13. The optical modem of claim 9, further comprising a transimpedance amplifier (TIA), wherein the power measurement device comprises a received signal strength indicator (RSSI) circuit to measure a resultant high speed photodiode (HS-PD) photocurrent at an input to the TIA.

14. The optical modem of claim 9, further comprising a LO source to produce the LO signal, wherein the LO source is configured to modify a power of the LO signal responsive to the feedback circuit.

15. An apparatus comprising:
one or more variable optical attenuators (VOAs) coupled to receive an optical local oscillator (LO) signal and to produce an output LO signal, the one or more VOAs configured to adjust an optical power of the output LO signal in response to a VOA control signal;
a mixer configured to mix the output LO signal and an incoming optical signal to produce a beat signal having a beat signal power;
one or more photodetectors configured to convert the beat signal into a photocurrent;
a transimpedance amplifier (TIA) configured to amplify the photocurrent to generate a voltage output signal representing the beat signal;
a power measurement device configured to measure the beat signal power and produce a signal representing the measured beat signal power; and
a feedback circuit configured to modify the VOA control signal in response to the signal representing the measured beat signal power.

16. The apparatus of claim 15, wherein the feedback circuit is configured to modify the VOA control signal to prevent the beat signal power from exceeding an operational threshold.

17. The apparatus of claim 15, wherein the TIA includes a variable gain.

18. The apparatus of claim 17, wherein the feedback circuit is further configured to modify the variable gain of the TIA.

19. The apparatus of claim 15, wherein the power measurement device comprises a received signal strength indicator (RSSI) circuit prior to the TIA.

20. The apparatus of claim 15, wherein the power measurement device comprises a digital circuit after the TIA to produce a digital value that represents the measured beat signal power.
